(19) United States
(12) Patent Application Publication
(10) Pub. No.: US 2024/0114857 A1
(43) Pub. Date: Apr. 11, 2024

(54) SYSTEM AND METHOD FOR PRODUCING CASING

(71) Applicant: Black Dirt Organics, LLC, Orem, UT (US)

(72) Inventors: Don Calvin Van Dyke, Orem, UT (US); Laroy Van Dyke, Loudon, TN (US); Owen Barnes, Lenoir City, TN (US); Phillip Davis, Jackson, TN (US); Josh Davis, Bradenton, FL (US)

(73) Assignee: Black Dirt Organics, LLC, Orem, UT (US)

(21) Appl. No.: 18/377,256

(22) Filed: Oct. 5, 2023

Related U.S. Application Data
(60) Provisional application No. 63/414,455, filed on Oct. 7, 2022.
(60) Provisional application No. 63/529,629, filed on Jul. 28, 2023.

(51) Int. Cl. A01G 24/28; A01G 18/22; A01G 18/50

(52) U.S. Cl. CPC A01G 24/28; A01G 18/22; A01G 18/50

(57) ABSTRACT

A method of producing leached compost casing may include washing compost to remove nutrients from the compost, drying the compost and using the compost as casing to grow plants. In some applications the compost may be pasteurized or sterilized while it is being leached.

### BACKGROUND

### Field of the Art

The present disclosure relates to a method for producing casing. In one aspect, the present disclosure teaches a method for creating leached compost casing for growing plants and fungi. In another aspect the present disclosure teaches a way to create a more customized nutrient solution for use in treating soil and plants.

### State of Art

There are a variety of situations in which a cover material is used for growing plants, fungi and the like. The cover material is often used to retain moisture while the plant or fungi grows to reach a desired size or to otherwise protect the growing organism. In one representative example, mushrooms are grown by disposing a layer of compost in a grow tray, inoculating the compost with spawn, and covering the compost with a cover material, typically called casing. The casing is used to maintain a moist environment as the spawn grow.

In the mushroom industry, casing is frequently made from peat. Peat is advantageous because it holds moisture well and has a small nutrient load. A casing with a high nutrient load can encourage the mushroom to remain in a “vegetative” state rather than encouraging “fruiting.” The use of peat, however, raises several issues. First, mining for peat can release vast amounts of carbon into the air and interferes with the area's ability to sequester new carbon. Peat mining can also affect local water quality and can disrupt ecosystems and the species that reside there.

Peat also has a low ph. of between about 3 and 4, while many plants and fungi prefer a more neutral environment. Mushrooms also prefer a ph. range of between about 6 and 8.

The use of peat is also problematic because the price of peat has increased considerably over the last year. This can add substantial expense to the cost of growing mushrooms. Additionally, the combined peat and compost mix (i.e., spent mushroom compost) left after the production of the mushrooms creates a substantial amount of byproduct which must be disposed of. While the spent mushroom compost can often be sold for gardening applications during the spring and summer, during the winter mushroom growers (and other farms using similar compost/casing mixes) often have to pay to dispose of the byproduct.

Attempts have been made to use the spent mushroom compost as casing. The spent mushroom compost (SMC), however, often contains far too many nutrients for the growing spawn and can substantially limit the ability of the mushrooms to fruit properly. Thus, there is a need for a new method for producing casing which minimizes one or more of the disadvantages of peat.

### SUMMARY

The following summary of the present disclosure is not intended to describe each illustrated embodiment or every possible implementation of the invention, but rather to give illustrative examples of application of principles of the invention. Furthermore, while the present disclosure is discussed in the context of creating casing for growing mushrooms but is not intended to be limited thereto. The process can be used to make leached compost casing (LCC) from other composts and casing for other plants can be made from SMC.

One or more of the above-referenced matters may be addressed in a method for making casing. The method may include taking compost (or a mixture of casing and compost), washing the compost to reduce the nutrient load and then drying the rinsed compost to a desired moisture content and then using the washed and dried compost as casing.

One or more embodiment of the present disclosure may include pasteurizing the compost by heating the compost to at least 140 degrees Fahrenheit (60 degrees Celsius) for at least 8-30 minutes to there by reduce the bacterial and fungi load in the compost as it is being leached.

On or more embodiments of the present disclosure may include pasturing the compost to at least 161 degrees Fahrenheit (72 degrees Celsius) for at least 8-30 minutes to kill off harmful bacteria and viruses. In one or more embodiments the compost may be sterilized by heating the compost to at least 220 degrees (F.) to kill substantially all the fungi and bacteria in the compost as it is being leached.

In one or more embodiments, the compost may be subjected to a first water bath to rinse nutrients from the compost. The first water bath may, for example, subject a given quantity of compost to between ½ and 2 times the amount of water by volume compared to the compost.

In one or more embodiments the compost may be allowed to soak in the water up to 4 hours before the water is released. During the soaking, nutrients in the compost may be dissolved in or suspended in the water, thereby carrying nutrients away from the compost when the water is removed.

In one or more embodiments the compost may be subjected to a second water bath to further reduce the nutrient load in the compost.

In one or more embodiments, water which has been cooled percolating through the compost may be drawn off in a first batch while additional water is allowed to percolate through the compost and further heat the compost to a desired temperature. The first batch of water which is drawn off may have a first nutrient profile due to the nutrients which are quickly removed from the compost, while a second batch may have a different nutrient profile due to being in contact with the compost for a longer period of time.

In one or more embodiments, the compost may be inoculated with beneficial microbes. In some applications, the microbes may be disposed in the water used for a first bath or a second bath.

In one or more embodiments, the compost may be formed by the mixture of the compost from a grow tray and the casing which was used on top of the compost.

In one or more embodiments, the compost may be dried to a predetermined moisture content.

In one embodiment, the compost may be used with a moisture content of between about 50 and 80 percent by weight.

In one or more embodiments, the compost may be subjected to forced air to remove moisture to from the washed compost to reduce the moisture content to between 10 and 50 percent moisture content and more preferably to between 20 and 40 percent moisture content. The forced air may also be heated to expedite the drying process.

In one or more embodiments, moisture may be removed from the compost by gravity, leaching, pressing, or centrifuging.

In one or more embodiments, the washed and dried compost may then be used to replace some or all of the peat normally used for casing. Because the nutrient load within the compost has been reduced by washing, the dried compost is safe to use with the mushroom spawn without harming the growing mushrooms.

In one or more embodiments, the compost may be washed until the dried compost will have a ph. between 6 and 8. Mushrooms and some other plants tend to grow best with a ph. between 6 and 8. Peat, however, is fairly acidic, having a ph. between 3 and 4.

In one or more embodiments the wet compost may be sun/air dried.

In one or more embodiments, the compost may be heated by having one or more probes inserted into the compost and steam or hot water injected through the probes to heat the compost to a desired temperature.

In one or more embodiments additives having a hydroxyl group may be added to the water to increase O₂ concentration in the water.

In one or more embodiments biologicals may be added to the compost either to prior to, during leaching, or after leaching to facilitate the leaching of various nutrients and/or pasteurization or sanitization. The addition of microbes can be used to increase composting action and to extract minerals, organic acids and hormones during the leaching process.

In one or more embodiments, the mixture of compost in an aqueous solution may be subjected to electrolysis to break down organic matter and create ions within the solution and thereby increase oxidation and release of nutrients into the water.

These and other aspects of the present disclosure are realized in a method for producing casing for plants, fungi and the like which may include one or more of the above-referenced features or aspects of the present disclosure.

In one or more embodiments, a casing which includes leached compost may be inoculated with mushroom spawn to accelerate mushroom growth.

In accordance with one or more embodiments, a mushroom may be produced by growing the mushroom in casing which includes leached compost,

In one or more embodiments, a nutrient solution may be formed by hot leaching spent mushroom compost and casing to form a soil amendment.

In one or more embodiments, a soil amendment may be formed by leached compost which is formed by hot leaching.

### BRIEF DESCRIPTION OF THE DRAWINGS

Various embodiments of the present disclosure are shown and described in reference to the numbered drawings wherein:

FIG. 1 shows a flow diagram of steps for producing casing for plants, fungi and the like.

FIG. 2 shows an alternate flow diagram for steps for producing casing for plants, fungi and the like.

FIG. 3 shows an alternate flow diagram for steps for producing casing for plants, fungi and the like.

FIG. 4 shows an alternate flow diagram for producing casing for plants, fungi and the like.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the apparatus and methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of examples of the invention and are not intended to narrow the scope of the appended claims. Furthermore, it will be appreciated that the drawings may show aspects of the invention in isolation and the elements in one figure may be used in conjunction with elements shown in other figures, etc.

Reference in the specification to “one embodiment,” “one configuration,” “an embodiment,” or “a configuration” means that a particular feature, structure, or characteristic described in connection with the embodiment may be included in at least one embodiment, etc., but need not be included in any particular embodiment. The appearances of the phrase “in one embodiment” in various places may not necessarily limit the inclusion of a particular element of the invention to a single embodiment, rather the element may be included in other, or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinary skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such an aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the plate” may include reference to one or more of such plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be more vertical than horizontal, i.e., would extend greater than 45 degrees from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

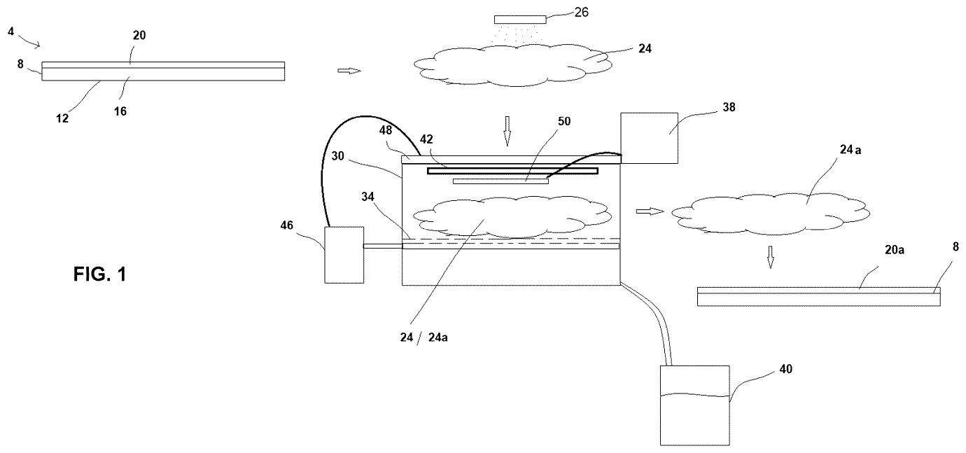

Turning now to FIG. 1, there is shown a diagram of a process for producing casing for plants, fungi and the like, generally indicated at 4. The process may start with plants, fungi or the like being grown in a grow bed 8. In the example shown, the grow bed 8 is designed for growing mushrooms. The grow bed 8 may include a grow tray 12 (often 4×8 feet) which includes a layer of compost 16 (often 6-8 inches deep) formed by a mixture of manure, a substrate such as straw, rice husk or wood pieces, and other desired additives. Fungal culture, mycelium, may be grown on a substrate, such as rice or grain to form spawn. The mushroom spawn is then disposed on the compost 16 to provide a nutrient source for the growing mushrooms. Casing 20 is applied as a layer to the surface of a mushroom crop before or after the compost is fully colonized to provide footing and a water supply for developing mushrooms. Alternative casing materials have been tried over decades with variable success, but peat moss remains a standard casing material in the mushroom growing industry. The inoculation of mushroom spawn may be exclusively on the compost, or may be at least partially in casing which includes leached compost.

The casing 20 is commonly formed with peat moss mixed with small amounts of limestone or gypsum and is often applied 1 to 2 inches deep. Peat moss is commonly used due to its ability to retain moisture while having a low nutrient load. The low nutrient load helps to encourage “fruiting” of the mushroom. The mycelium is the vegetative body of the mushroom while the fruiting body produces spores for reproduction. The fruiting body which grows out of the compost is the portion which is harvested and sold as “mushrooms.”

Once the mushrooms are harvested, the spent mushroom compost (SMC) 24 is dumped from the trays. (The SMC may be certified organic—thus allowing the grower to certify his or her crop as organic). The compost 16 and casing 20 may be mixed together. Traditionally, mushroom growers would either sell the spent mushroom compost as a byproduct which can be used for use in gardens, or would have to pay to have the spent mushroom compost hauled off and disposed of in a landfill or the like.

U.S. Pat. No. 8,641,797 teaches a method for processing the spent mushroom compost to extract fulvic and humeric acid. That process involved soaking the spent mushroom compost 24 and filtering the effluent to obtain a liquid fertilizer. The leached compost was then sold off as a garden amendment. The disclosure contained in U.S. Pat. No. 8,641,797 is expressly incorporated herein.

In accordance with the present disclosure, it has been found that the spent mushroom compost (SMC) 24 can be processed to produce a nutrient reduced compost which can be used as casing 20. In the present disclosure, leached compost casing (LCC) will be used to designate the final product of a compost which has had nutrients removed so that it can be used as casing regardless of the method by which (or if) the moisture is removed from the compost. The LCC 24a can be used in a mixture with peat in a compost grow bed 8 in a grow tray 12 as the casing 20. Alternatively, the LLC 24a may be used in place of the peat. The reduction in the amount of peat used is both a financial savings for the mushroom growers and an environmental benefit by reducing the environmental impacts caused by the mining of peat. This can include carbon release, reduced carbon capture and water contamination.

The grow tray 12 is typically inverted so that the compost 16 and casing 20 fall out or is otherwise emptied to leave a pile of SMC mushroom compost 24. A spray system 26 may be used to inoculate the SMC 24 with biologics or microbes to facilitate the release of various nutrients within the SMC and/or to facilitate pasteurization. For example, REVITA N or MOREPHOS available from BTI of Dallas, Texas, may be added to the SMC 24 to facilitate the release of phosphorous or other nutrients from the SMC during the leaching process. This may be done to increase the amount of particular nutrients in the leaching solution to make it more usable for particular purposes or may be done to reduce excessive load for particular nutrients in the SMC. For example, the MOREPHOS may be used if the compost has a high level of phosphorous that needs to be removed prior to using the compost as casing.

Biologicals and microbes can also be added to reduce the presence of undesirable fungi or bacteria in the SMC prior to the leaching process to reduce their load both in the compost and in the leaching solution.

The SMC may be dumped directly into a processing vat or tank 30, or into a pile in a storage area for later processing and the spray system 26 may be contained adjacent the tank 30 or in the storage area. Whether the SMC is dumped directly into the tank or is held in a storage area may depend on the nutrient load and what biologicals or microbes are being added.

The processing tank 30 may include a false bottom 34 having a plurality of holes formed therein. The SMC 24 may be disposed on the false bottom 34 as shown in FIG. 1.

In situations where it is desired to use the leached solution (also referred herein as effluent) from treating the SMC 24, the compost will typically be pasteurized or sterilized prior to the first bath so as to reduce the risk of pathogens being transmitted in the effluent. This can be done prior to placement of the SMC 24 in the tank 30, or as an initial step before bathing the compost in water.

Pasteurization may also occur by using hot water and/or steam which has been heated to perform the first bath. Sterilization could occur by closing the tank 30 and injecting steam into the tank sufficiently to sterilize the compost.

The SMC 24 may then be bathed with water from a water supply system 38. Depending on the amount of nutrient load which is wished to be removed and the desired byproducts, the water supply system 38 may simply sprinkle the spent mushroom compost 24 with water until the nutrient load is below to a desired threshold. Such a process may use a substantial amount of water which ultimately has been enriched with a low nutrient load. That water could then be used for a variety of purposes, such as irrigating crops with water enriched with nutrients, but at a level which is unlikely to “burn” or otherwise harm the crops.

Alternatively, the processing tank 30 may be filled with sufficient water that the SMC 24 is completely submersed. The SMC 24 may be held in such a state for, as an example, 5 minutes to 4 hours, with the longer the duration leading to water having a higher nutrient load, and the SMC having a lower nutrient load. The water can then be filtered and drained off into a solution handling unit 40. The nutrient infused solution can be sold as liquid fertilizer or processed to remove the nutrients for other applications.

The LCC 24a has a reduced nutrient load, thereby rendering it more usable as casing for growing plants and the like, as the compost no longer contains a high nutrient load which could interfere with the desired growth of the plants, fungi or the like, such as fruiting of mycelium to produce mushrooms for harvest. Different plants and even different types of fungi will be sensitive to different nutrient loads, so that leached compost 24a may be treated until it has the desired nutrient load for a particular application.

If the first bath does not reduce the nutrient load in the spent mushroom compost 24 to the desired level, the spent mushroom compost 24 may be subjected to a second bath and potentially a third bath to remove sufficient nutrients. For example, a mushroom grower may wish to reduce the load of soluble salts from 7500 PPM to 400 ppm and/or may wish to reduce the Nitrogen from 14% to 4%. As different plants and fungi have different sensitivities, the process for reducing the undesirable nutrient loads to a desired level may vary depending on the crop being grown. The baths may be repeated until the grower believes that the nutrient load is below the desired threshold.

One or more of the baths can also be used to inoculate the compost with beneficial bacteria and other microbes which may have been killed off during pasteurization or sterilization if either is done to the SMC 24 before or during the first bath. Likewise, inoculation may be done during a second or subsequent bath, which may be done at a lower temperature to avoid harming the beneficial bacteria or other microbes.

Once the water is drained from the tank 30 containing the compost, which is now leached compost 24a, the moisture content of the compost is typically about 75 percent and may be used at such. This can be reduced, if desired, by using a press 42 to drive water out of the compost. The tank 30 can be spun so that the centrifugal force causes the water to separate from the compost. Additionally, an air blower system 46 may be used to further dry the compost. The air blower system 46 may range from a simple fan to a plurality of probes which extend into the compost and inject pressurized air to promote drying. Additionally, the tank 30 may be sealed sufficiently that pressurized air may be introduced to help drive the nutrient enrich solution from the tank and into the solution handling unit 40. Those skilled in the art will appreciate that there are numerous drying mechanisms for reducing moisture including numerous presses, centrifuges, blowers and the like which can be used to reduce the moisture content of the LCC 24a to a desired level.

Wet LCC 24a could also be disposed in the open air to dry in the shade or in direct sunlight to further reduce water content. It has been found that a water content of below 50 percent is preferred in growing mushrooms so that the leached compost can be used in the machinery typically used to add the casing onto the grow beds 8. A higher moisture content tends to clog the machinery. Too low of a moisture content may make it difficult to rehydrate the leached compost after it has been applied as casing. Thus, a presently preferred range for moisture content for “dry mixing” LCC is between 20 and 40 percent, with 30 to 40 percent being the presently most preferred range with the equipment used in developing the technology of the present disclosure. It will also be appreciated that for other crops different moisture contents may be desirable. When used in combination with peat, the relatively dry peat and LCC are mixed and then moistened and placed on top of the compost contain the crop to be grown to thereby provide moisture.

In another application, it has been found that using wet LCC 24a with a moisture content of between 50 and 70 percent by weight may mixed with peat which has been moisturized consistent with conventional application of peat. This is typically accomplished by adding a second auger for the LCC so that the LCC does not clog up the dry mixer used for the peat. The wet mixture of peat and LCC may then be applied to the compost trays as casing. This reduces the time and expense associated with drying the LCC.

The air blower system 46 may be used to blow ambient or heated air through the leached compost 24a to help dry the compost. Depending on the moisture content obtained and the desired moisture content, the leached compost 24a in the tank 30 may be dispensed directly into the machinery use to apply the casing, or it may be dumped for further drying or processing depending on the intended use. For example, a user may desire for the added microbes to grow for several days before the compost is used as casing. This could be done in tank 30 or in a curing pile while the tank is being used to process additional compost.

The discussion above has referred to the starting compost as being spent mushroom compost. The use of such is advantageous for mushroom growers as it reduces the amount of byproduct which must be disposed of and simultaneous reduces the amount of product which must be imported into the facility, reducing the time and cost associated with bringing in and storing peat or the like. However, it will be appreciated that compost other than spent mushroom compost may be used to create casing which is sufficiently low in nutrient load to promote the growth of mushrooms or other plants.

The dried leached compost casing 24a may be applied in the same manner as peat-based casing by dumping the compost into the processing equipment which is currently designed to cover the compost 16 in the grow tray 12 with the peat casing. The leached compost 24a can be used exclusively, or it may be mixed with peat or other compost and used as casing 20. By using compost in place of some of the peat, substantial savings can be achieved, and less harm is done to the environment by minimizing the amount of peat being mined.

While 100 percent leached compost may be used, the inventors have found that mixtures of 10-90 percent compost and 10-90 percent peat work, with a range of 30-70 percent peat and 30-70 leached compost providing the most desired casing. It will be appreciated that the most desired mixture ranges may depend on the product being grown, the atmosphere within the growing area, and even the specific species. Thus, for example, one species of mushroom may perform well with a 100 percent compost casing, while another may perform better with a casing which is only 20 percent compost casting. Either way, however, substantial economic and environmental benefits can be obtained by reducing the amount of peat which is being used.

In conjunction with the method of present disclosure, a grow tray of mushrooms and the resulting processing of the spent mushroom compost (SMC) to form leached compost casing (LCC) may be treated in one representative example as follows:
1. Kill off a crop of mushrooms by post-cropping (typically at 145-150 degrees F. or more). for 6 hours.
2. Remove SMC 24 from cropping trays or shelves.
Optional 2A. inoculate the SMC 24 with biologicals or microbes.
3. Fill the leaching tank 30 with SMC.
4. Flood the tank 30 with water (optionally using a manifold to distribute the water).
5. Soak SMC 24 for 5-240 minutes to leach nutrients from the SMC and then drain.
6. (Optional) Flood the tank 30 a second time for 5-240 minutes and drain.
7. (Optional) Attach the tank lid 48.
8. Remove water from the SMC 24 (This may be done, e.g., by using pressurized air from the air blower system 46 for 10-120 minutes to force remaining liquid down through the tank filter.)
9. (Optional) Use pressurized air forced up through the bottom of the tank for 10-120 minutes to reduce moisture.
10. Inject steam to pasteurize the leached compost.
11. Stop pasteurization by forcing air up through the tank.
12. Stack processed tanks in the peat room annex.
13. Open tank over a material handling bin with a flight chain to transport/meter LCC 24a into the peat auger system to blend with peat moss. Add water as needed.
14. Process and apply to crop as with typical casing material 20a, using current casing equipment.
15. Grow crop with the LCC casing material

It will be appreciated that multiple of these steps may be omitted or combined with other steps and this list is provided only by way of example.

The leaching tank 30 may be modified with a top hinged side to accommodate emptying during the casing process. A water distribution manifold 50 and the air blower system 46 may be built into an otherwise airtight lid 48 for flooding, forcing excess liquid out after the final leaching, containing steam during pasteurization, and to protect finished LCC 24a from contamination prior to use. Steam ports may be provided at various points around the tank but may not be needed if steam can be successfully introduced through the filter at the bottom of the tank. If steaming from the bottom only causes uneven heating or overheating of zones within the tank, the steam ports may be used to insert hypodermic style steam lines into the interior of the tank. The tank may be transportable via forklift as well as stackable for more compact storage prior to using the LCC 24a product. The current—or modified loader attachment mechanism may be used for emptying tanks into the casing operation.

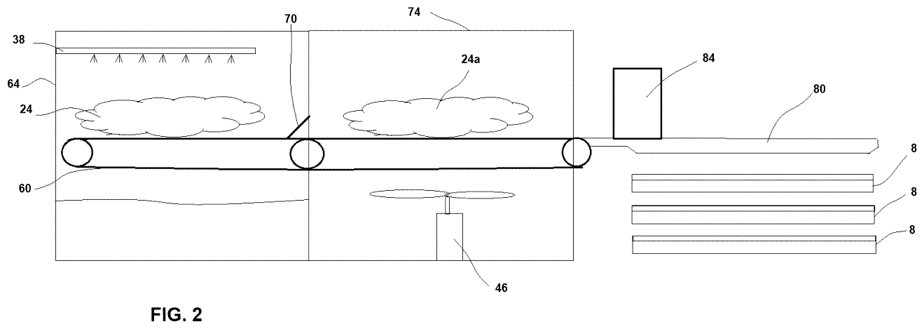

Turning now to FIG. 2, there is shown an alternative processing system. While all of the steps discussed above could be performed within a vat or tank, they could also be performed along a moving system, such as a conveyer belt 60. The spent mushroom compost 24 may be disposed in a first chamber 64 in which a water supply system 38 may be used to pasteurize or sterilize the SMC 24 by injecting steam or hot water. While not show, a spray system such as 26 in FIG. 1 could be used to inoculate the SMC 24.

The water supply system 38 may completely submerge the SMC 24, or the water may be applied in such a way that the water is able to stay on the SMC a sufficient amount of time to leach out nutrients. This could be done, for example by the conveyer belt 60 having holes which are sufficiently small that the water percolates through them very slowly. A deflector 70 could also be used to maintain the water in the first chamber 64.

The conveyer belt 60 could then be activated to move the now leached compost 24a into a second chamber 74 where the leached compost or LCC 24a is dried by the air blower system 46. Once dried to the desired moisture content, the conveyer belt 60 can transport the LCC 24a into a casing distribution system 80 which can apply the LCC 24a to the grow beds 8. The casing distribution system 80 may also include a mixing hopper 84 for mixing the LCC with other casing material such as peat, gypsum or limestone.

While the use of spent mushroom compost is advantageous as it uses a byproduct of growing mushrooms, it will be appreciated that the compost 24 need not be spent mushroom compost. Rather the compost 24 may be compost which is the byproduct of other growing activities, or may be compost which is made specifically to be used as casing in other growing operations. Thus, for example, a person or entity wishing to make casing may mix straw, wood chips or other carbon sources with manure or other nitrogen sources to make a compost and then process the compost as follows:
1. Pasteurize, sanitize or sterilize compost 24 by heating the compost to an appropriate temperature (such as 161 degrees Fahrenheit/72 degrees Celsius for pasteurization, 171 degrees Fahrenheit/77 degrees Celsius for sanitization and 250 degrees Fahrenheit/121 degrees Celsius for sterilization) for a desired length of time. It will be appreciated that pasteurization can occur at lower temperatures applied over a longer period of time. Additionally, the load of viruses and harmful bacteria may dictate what constitutes sufficient pasteurization. Thus, for some applications heating the compost to 130, 140 or 150 degrees for a given period of time may be deemed sufficient to reduce the viral/bacterial/microbe load sufficiently that the compost will be safe to use for casing.
2. Place the compost 24 in the leaching tank 30. (Steps 1 and 2 may be reversed if the step of killing undesirable microbes and viruses is to be performed within the leaching tank 30).
3. Add water to the compost 24 in the leaching tank 30 to leach nutrients out of the compost. This step may include multiple washings of the compost 24 or simply soaking the compost for a length of time between 5 minutes and 6 hours depending on the nutrient level contained in the compost before leaching and the desired nutrient level in the leached compost 24a. (It will be appreciated that steps 1 and 3 could be combined if the water being added is being used to pasteurize the SMC 24 in the leaching tank. As will be discussed in additional detail below, the use of hot water can both pasteurize the compost and facilitate the release of nutrients from the compost at the same time.)
4. Drain water from the leached compost 24a and dry the compost to a desired moisture content. The drying may occur within the leaching tank 30 or after the leached compost has been removed from the leaching tank 20. Drying may occur by pressing the leached compost, subjecting the leached compost to a centrifuge, forced air drying the compost or simply allowing the compost to dry under the sun or in ambient air. It will be appreciated that sun and ambient air drying will be affected by the ambient temperature and humidity of the environment in which the leached compost 24a is performed.
5. Applying the leached compost to a substrate on which a crop will be grown to form casing.

It will be appreciated that various steps of the process may be repeated. For example, the compost 24 may be repeatedly washed to produce leached compost of a desired nutrient content. The leached compost 24a may be subjected to multiple forms of drying, such as pressing and then forced air. The leached compost 24a may be pasteurized, sanitized or sterilized again prior to usage. Additionally, additives such as beneficial microbes or additives having a hydroxyl group may be added to water or to the leached compost to provide desirable biological activity or additional O₂ in the leaching fluid (typically water) or in the resulting leached compost 24.

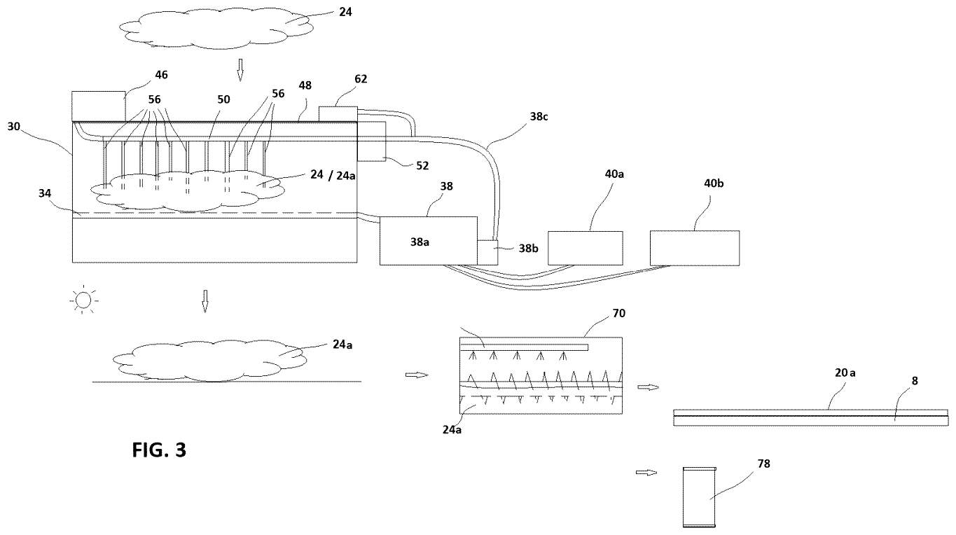

Turning now to FIG. 3, there is shown an alternate flow diagram for steps for producing casing for plants, fungi and the like. The compost 24 need not be formed by spent mushroom compost but may be made from a variety of different composts depending on what is available and economically feasible for the plant, fungi or other crop to be grown. The compost 24 may be placed in a processing tank 30 which may have a false bottom 34 or otherwise provides a drain. A water supply system 38 may include a water supply container 38a, a pump 38b and a feed line 38c for transporting water to a water distribution manifold 50. A heater 52 may be disposed in the water supply container 38a, in the pump 38b, along the feed line 38c or along the water distribution manifold 50 to heat the water and, if desired, change the water to steam.

The water distribution manifold 50 may include a plurality of probes 56 which may stick into the compost 24 to inject steam and/or water into the compost. The steam and/or water can serve two purposes. First steam or heated water can be used to pasteurize, sanitize or sterilize the compost to prevent any viruses, bacteria or other harmful microbes from being passed on. Second, the steam or water can be used to leach nutrients out of the compost. This may be done in a single process, such as allowing the compost 24 to soak in water for a given length of time, or may be done by repeat processes, such as repeatedly rinsing the compost with the water.

One challenge with properly pasteurizing, sanitizing, etc., the compost 24 is that as compost becomes saturated with water, it is harder for the water to pass through the compost. Additionally, as a large batch of compost 24 may have considerable mass, the steam or hot water which initially contacts the compost will quickly cool down to a temperature below where pasteurization, sanitization or sterilization will occur. Thus, if the water is applied from the top, the water which percolates to the bottom may be considerably lower in temperature by the time it reaches the bottom of the compost. The compost will slow the transmission of heat from the hotter water above to the cooled water below. Thus, in accordance with one aspect of the present disclosure, it may be desirable to draw off a portion of the water a short time after introduction. This may be at little as 10 percent of the water volume to 50 percent of the water volume depending on the amount of water used per volume of the compost. This allows hotter water above to percolate through the compost and ensure that the temperature within the compost surpasses the minimum temperature to properly pasteurize, sanitize or sterilize the compost.

The drawn off water may be treated in several different ways. In one application, the drawn off water may simply be passed back into the water supply system 38 by reentering the water supply container 38a, where the pump 38b can recirculate the water through the feed line 38c and back through the heater 52 to be returned to the compost 24 by the water distribution manifold 50. While the system may be designed to return a designated volume, the draw off of the water may also be done based on temperature, such as drawing off water until the temperature of the water passing through the compost reaches some desired threshold, such as 150 degrees or 160 degrees, at which point the operator knows the remaining hot water in the tank 30 is sufficient to being the compost to the needed temperature for pasteurization, etc.

Alternatively, the drawn off water may be directed to a solution handling unit 40a. This may be in conjunction with the water supply container 38a, or independent therefrom. Different nutrients have different solubilities in water or other solvents. When washing compost with water, some nutrients will dissolve faster in the water than others. Thus, it is likely that the water which is drawn off shortly after being applied to compost will have a different nutrient load than water in which the compost has been soaking for several hours or days. Depending on the nutrient load of the compost, it may be desirable to capture the drawn off water which has higher levels of some nutrients and lower levels of others for specific application purposes. For example, the drawn off solution may have a relatively high load of sulfur which is easily soluble in water, while having less nitrogen which is less soluble in water. Thus, for applications in which a high level of sulfur is desired without a high level of nitrogen, the first drawn off solution is ideal. In other situations, the first drawn off solution may simply contain higher amounts of certain nutrients which are not desired and can be disposed of as necessary. The later drawn off solution may have the desired mix of nutrients.

The water/nutrient solution in which the compost has soaked may be drained off to the solution handling unit 40b, from which may be packaged or otherwise used for applications best correlated to the nutrient profile of that solution. For example, the water/nutrient rich solution may have many times more beneficial nutrients due to the prolonged soaking and thus may be more beneficial for fertilizing plants with high nutrient demand, such as vegetable crops for human consumption. Moreover, if the solution has been effectively pasteurized while leaching the nutrients from the compost, there is less risk that the “fertilizer” formed by the nutrient rich solution will have pathogenic bacteria or fungi.

While the discussion above had primarily focused on water as being the solvent in the compost 24 for removing nutrients, it will be appreciated in light of the present discussion that other solvents could be used to remove nutrients from the compost. For example, solutions containing compounds with hydroxyl group or hydrogen peroxide are desirable solvents for removing beneficial nutrients from due to their strong oxidation potential. The oxidation also helps to kill pathogens. Thus, a solution including compounds with hydroxyl groups or hydrogen peroxide could be used for applications wherein it is desirable that the leached compost 24a have very low amounts of pathogens without excessive heating.

Similarly, while discussed above generally in the context of effectively flooding the compost 24 with a solvent such as water, it will be appreciated that steam could be used throughout the leaching process to facilitate extraction of the nutrients from the compost. As the steam condenses the water will carry away the extracted nutrients.

Also shown in FIG. 3 is an additive container 62. The additive container 62 may contain additives to be applied to the compost and/or the water or other solvent being used to remove nutrients from the compost 24. For example, the additive container 62 may have beneficial microbes which may be added to the compost either directly from the additive container or through the water distribution manifold. Alternatively, or additionally, the additive container may hold solutions to enhance the functioning of the solvent. For example, additives such as chemicals having a hydroxyl group could be added to water to increase the amount of O₂ in the solvent.

An air blower system 46 may also be included. The air blow system 46 may be disposed in communication with the water distribution manifold 50 for injecting air into the compost. The injected air may be used to force water or other solvent out of the leached compost 24a. It may also be used to oxygenate the compost to promote the growth of beneficial microbes.

The leached compost 24a may then be removed from the processing tank 30 and allowed to dry in ambient air or under direct sunlight. The use of natural evaporation typically takes longer to reach the desired moisture content and is somewhat less controlled than active moisture removal, but such a process reduces the amount of energy input required by pressing, centrifuging, blow drying, etc., the leached compost 24a, thereby reducing the cost.

Once the leached compost 24a has dried sufficiently, the leached compost may be passed through a mixer 70. It will be appreciated that if the compost is left to dry in a pile and not turned, etc., the interior portions of the pile will tend to have a moisture content which is higher than that of the compost near the exterior of the pile. Thus, the mixer 70 mixes the dryer compost with the moister compost to obtain compost which has a moisture content within the desired range. If the leached compost 24a is too high in moisture content, additional dry leached compost may be added. If the moisture content is too low, a mister 76 or other moisture injection mechanism can be used to bring the moisture within desired parameters. The mixed leached compost 24 may then be applied on a substrate as casing 20a. Alternatively, it can be placed in a bag 78 or other container for use at a later time or an alternate location.

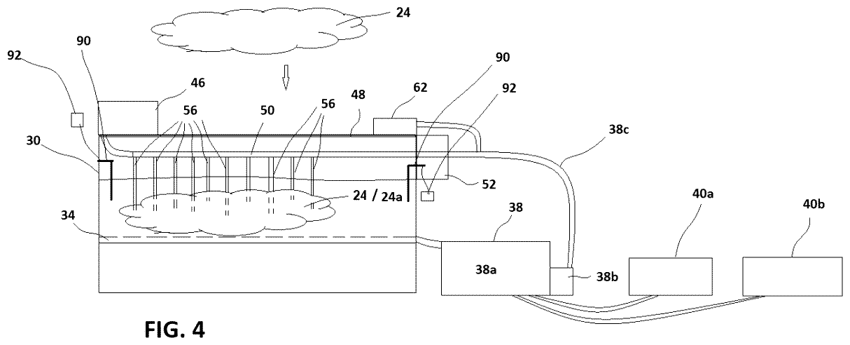

FIG. 4 shows an alternate flow diagram for producing casing for plants, fungi and the like. The compost 24 may be obtained in a variety of ways. For example, while it is common to kill off the growth of spent mushroom compost after the mushrooms have been harvested by heating the grow tray to 150 degrees for 6 hours, the spent mushroom compost and the casing disposed thereon can simply be dumped directly into the processing tank 30 without further processing after the mushrooms have been harvested.

The processing tank 30 shown in FIG. 4 is generally similar to that shown in FIG. 3 and is numbered accordingly. The processing tank 30 may also include one more electrodes 90 which may be disposed in electrical communication with one or more power sources 92, such as a battery, a conventional building electrical system, or alternative power systems such a solar, wind or other power sources. During the soaking of the compost 24 in the water or other solvent, the electricity may be passed through the compost/solvent mixture by energizing one or more of the electrodes to thereby facilitate the release of some nutrients from the compost by allowing ions to disassociate. Tests have shown an increase in electrical conductivity of the resulting solution by five percent (5%) or more, suggesting that the nutrient load in the solution is higher than a similar solution processed in the same way, but without the electrolysis. The current may be adjusted to regulate the levels of separation of minerals into the solution.

Some of the solvent may be drawn off into a solution handling unit 40a before the application of the electrolysis to avoid having a high load of non-beneficial nutrients, while solvent after the application of the electrolysis may be pumped into another solution handling unit 40b after the electrolysis has facilitated the release of the more beneficial nutrients.

After the electrolysis has been performed and the solvent drained, the leached compost 24a may then be processed by active drying such as discussed regarding FIGS. 1 and 2, or passive drying as is discussed with respect to FIG. 3. While shown in separate drawings to ease of reference, it will be appreciated that the different aspects of the specification and drawings can be interchanged and used together based on the compost material which is available, the availability of active and passive drying resources, and the particular needs for the casing to be produce. Thus, the fact that a particular structure or feature is shown or discussed with respect to one drawing does not mean that the feature is required or that an alternate feature or structure could not be used in its place.

In accordance with one aspect of the present disclosure it has been found that leaching the SMC 24 at room temperature has a disadvantage if the LCC 24a is going to be used as compost. The leached compost is waterlogged and takes more energy to repastuerize.

In contrast, the spent mushroom compost is typically about 100-120 degrees Fahrenheit coming out of the trays and may be as high as 140 degrees Fahrenheit. If a load of 2.5 cubic feet is being treated in the tank 30, water may be added which is between 140 to 220 degrees Fahrenheit. The water temperature most typically used will be 140 to 180 degrees Fahrenheit with a presently preferred temperature range of 150-165 degrees Fahrenheit. It will be appreciated that the preferred temperature range may be dependent on the microbe load in the compost with high pathogen loads requiring higher temperatures and/or longer treatment periods.

Between about 160-230 gallons of hot water may be added depending on the moisture content and temperature of the compost. The compost in the water will settle to about 2 cubic feet. Approximately 80-140 gallons of water may be drawn off and a similar amount of water reheated to 140-180 degrees may be added back into the tank to ensure that all of the compost reaches at least 140 degrees both for pasteurization and to encourage nutrient transfer to the water. In many situations those leaching the compost may desire the minimum temperature to be at least 150 degrees or 160 degrees Fahrenheit. The solution of water and nutrients may be drained and then compost dried to a predetermined moisture content. The leached compost may then be used as casing without further processing or pasteurization.

The solution may be used as fertilizer or in other applications. For example, U.S. Pat. No. 8,641,797 teaches the use of cold leached nutrients in a solution for fertilizer and other applications, resulting in substantial increases in plant yield. The nutrient solution is used as foliar application, i.e., sprayed on the leaves and stems of plants to increase bioavailability of liquid fertilizers. It can also be used to pretreat seeds prior to planting or in the seed furrow.

In had been found in accordance with the principles of the present disclosure, that the hot leaching (i.e., leaching nutrients with water of at least 140 degrees Fahrenheit) can be used to alter the nutrient load in the resulting solution. Specifically, using a hot leaching process reduces the microbiome, alters the levels of various enzymes which are critical to plant growth, some of the enzymes increasing and some decreasing. The hot leaching process also increases certain organic acids, such as gibberilac acids. This nutrient solution is more suited for soil applications and blending with other soil amendments.

Thus, depending on whether one desires a nutrient/microbiome/enzyme load similar to that obtained in U.S. Pat. No. 8,641,797 or that achieved by hot leaching, may dictate whether a first leaching of the SMC 24 is done with ambient water or heated water as explained above. If done with the cool leaching process, the LCC 24a will then be subjected to a second leach or exposure to hot water to pasteurize, sanitize or sterilize the LCC prior to use as casing depending on the preferences of the grower. It will be appreciated that the LLC can be subjected to a second hot leaching both to reduce nutrients for the LCC 24a and to further pasteurize the LCC to ensure that no pathogens are passed back to the growing trays.

One representative method for forming LCC is:
1. Obtaining a mixture of SMC and casing post crop.
2. Leaching nutrients of the SMC-casing mixtures at least once with a water (or fluid) between 140-220 degrees Fahrenheit for at least 5 minutes. (The amount of time will vary depending on the volume of SMC-casing mix and the amount and temperature of the liquid. For example, at 140 degrees 90 minutes of exposure may be used, while at 160 degrees 20 minutes might be used)
3. Draining off leached nutrient solution.
4. Using the leached SMC as casing for further crop production.

It will be appreciated that the present disclosure has several novel products. First, the hot leaching process is used to make a nutrient solution which is desirable as a soil amendment, and which has different properties than the solution obtained by the previously discussed patent. Likewise, the leached SMC 24 can be used as a soil amendment and may be bagged or otherwise distributed to for use in gardens, farms and the like. Additionally, the leached SMC 24a can be used as compost casing for the growing of mushrooms or other crops, thereby reducing the expense and environmental impact of using peat as the primary casing material.

In accordance with another aspect of the present disclosure it has been discovered that use of the leached compost casing in addition to or in complete substitution for peat can accelerate the growth of the mushrooms. Specifically, it has been determined that the mushrooms emerge one day sooner than mushrooms grown in a casing which is primarily peat and thus reach a harvest size on average one day earlier. This allows production to increase by approximately 3 percent.

Thus, there is disclosed a method for producing leached compost casing. Numerous modifications to the various embodiments discussed herein will be apparent to a person of ordinary skill in the art and the appended claims are intended to cover such modifications.

What is claimed is:

1. A method for producing leached compost comprising:
obtaining a mixture of spent mushroom compost and casing;
subjecting the mixture of spent mushroom compost and casing to a fluid of between 140 and 220 degrees F., the fluid leaching nutrient from the mixture of mushroom compost and casing to form leached compost; and
drawing off a nutrient solution to leave leached compost having a reduced nutrient load.

2. A nutrient solution formed by the method of claim 1.

3. A soil amendment comprising the leached compost formed by the method of claim 1.

4. The method of claim 1, wherein the leached compost is used as casing to grow crops.

5. A mushroom having been grown in casing formed the leached compost formed by the method of claim 1.

6. The method according to claim 1, wherein the method further comprises adding beneficial microbes and/or biologicals to the mixture of spent mushroom compost and casing.

7. The method according to claim 6, wherein adding beneficial microbes and/or biological comprises infusing the mixture of spent mushroom compost and casing with water containing beneficial microbes and/or biologicals.

8. The method according to claim 1, wherein the method comprises drying the leached compost until the leached compost has a moisture content of less than 50 percent by weight.

9. The method according to claim 8, wherein the method comprises drying the leached compost until the leached compost has between 20 and 40 percent moisture by weight.

10. The method according to claim 8, wherein the moisture content of the leached compost is between 30 and 40 percent by weight.

11. The method according to claim 1, wherein the method further comprises disposing the leached compost on a grow bed which has been inoculated with mushroom spawn.

12. Casing for used in growing crops comprising leached compost made in accordance with the method of claim 1.

13. A method for growing a crop comprising applying leached compost formed in accordance with claim 1 in a mixture with peat to form a casing layer and wherein the peat is between 10 and 90 percent of the mixture.

14. The method according to claim 13, wherein the mixture of leached compost formed in accordance with claim 1 and peat, and wherein the mixture is between 10 and 90 percent leached compost.

15. The method according to claim 1, wherein the method wherein the fluid comprises at least one of water and a solution and wherein mixture of spent mushroom compost and casing soaks in the at least one of one water and solution, the at least one of water and solution having a temperature sufficient to pasteurize the mixture of spent mushroom compost and casing while the mixture of spent mushroom compost and casing soaks in the at least one of water and solution.

16. The method according to claim 1, wherein the fluid is steam and wherein the mixture of spent mushroom compost and casing is disposed in a processing tank.

17. The method according to claim 1, further comprising subjecting the mixture of spent mushroom compost and casing to electrolysis while the fluid is present.

18. A method for growing mushrooms, the method comprising:
selecting a layer of compost which has been inoculated with mushroom spawn; and
covering the layer of compost with casing comprising leached compost which has been leached to lower the nutrition load.

19. The method according to claim 18, wherein the casing is formed by mixing leached compost with peat.

20. The method according to claim 19, wherein the casing is inoculated with mushroom spawn.

21. The method of claim 15, wherein the leached compost was formed by subjecting a mixture of spent mushroom compost and casing to at least a first bath to remove nutrients from the compost.

22. The method of claim 21, wherein the leached compost has been pasteurized during leaching.

23. The method according to claim 21, wherein the leached compost was formed by subjecting compost to a second bath to remove additional nutrients from the compost.

24. The method according to claim 18, wherein leached compost has been inoculated with microbes and/or biologicals.

25. The method according to claim 18, wherein the leached compost was formed, in part, by sterilizing spent mushroom compost by at least one of hot water or steam.

26. A method for using leached compost, the method comprising:
selecting compost which has been subjected to a solvent to leach nutrients from the compost and thereby form leached compost having sufficient solvent removed from the compost to so to form leached compost that has a moisture content between 30 and 70 percent by weight; and disposing the leached compost on a substrate for form a casing for growing plants or fungi.

27. The method according to claim 26, wherein the substrate is compost.

28. The method according to claim 23, wherein the method comprises selecting leached compost which has been subjected to electrolysis during leaching.
